(19) United States
(12) Patent Application Publication
(10) Pub. No.: US 2024/0273730 A1
(43) Pub. Date: Aug. 15, 2024

(54) TARGET REGION ANALYSIS SYSTEM AND METHOD FOR BIOLOGICAL DETECTION

(71) Applicant: SHANDONG NORMAL UNIVERSITY, Jinan (CN)

(72) Inventors: Guanliu YU, Jinan (CN); Ping FENG, Jinan (CN)

(21) Appl. No.: 18/471,962

(22) Filed: Sep. 21, 2023

(30) Foreign Application Priority Data
Feb. 13, 2023 (CN) 202310105717.1

(51) Int. Cl. G06T 7/11

(52) U.S. Cl. CPC G06T 7/11; G06T 2207/30181

(57) ABSTRACT

Provided a target region analysis system for a biological detection, including a sample pushing mechanism for pushing a liquid sample for the biological detection onto a detection glass substrate at a detection station; a gradient analysis equipment for performing a pixel value on each pixel point in the image to be processed; a fitting operation device for obtaining a plurality of image regions in the image to be processed; a region identification device for acquiring a region to be detected for performing the biological detection. Also provided is a target region analysis method for the biological detection.

### CROSS-REFERENCE TO RELATED APPLICATIONS

This disclosure claims priority to Chinese Patent Application No. 202310105717.1, filed on Feb. 13, 2023, the contents of which are hereby incorporated by reference.

### TECHNICAL FIELD

The disclosure relates to a technical field of biological detection, and in particular to a target region analysis system and a target region analysis method for a biological detection.

### BACKGROUND

Biological detection is to clarify the environmental pollution situation by using the reaction of biological individuals and populations to environmental pollution or changes, and provide biological detection data for monitoring and evaluating environmental quality from a biological point of view. At the same time, the biological detection may also directly obtain the parameters of various biological life characteristics for judging corresponding life performances.

Since environmental change is fundamentally an impact on the biological system with human as the main body, the biological detection is more direct and indicative on the environmental quality, and at the same time, because it is necessary to know the infection of various viruses or bacteria in the organism, biological detection also has a direct and indicative role in the quality of various life characteristics of the organism. However, due to the complexity of the monitoring object of the biological detection, the operation of biological detection faces many problems. And the sensitivity, rapidity and accuracy of the biological detection need to be further improved.

For example, when a liquid sample for biological detection is pushed onto a detection glass substrate at a detection station to detect the biological features in an imaging picture by using a macro imaging mode to judge whether the environmental quality is good or not or whether various biological life features are good or not, it is difficult to obtain an accurate edge of the liquid sample due to the uneven spreading shape of the liquid sample on the glass substrate, so that the imaging area of the liquid sample cannot be divided and subsequently detected. If the whole glass substrate is detected, the detection range is too large and the detection range will be too large. If the whole glass substrate is inspected, the inspection range will be too large and the calculation amount will be large, and the sensitivity, rapidity and accuracy of inspection will be affected.

### SUMMARY

In order to solve the above technical defects, the present disclosure provides a target region analysis system and a target region analysis method for a biological detection, so as to introduce a targeted pixel value gradient analysis mechanism and a comparison mechanism of image areas, and divide the image areas of biological detection liquid samples with uneven shapes on a glass substrate as a whole for subsequent biological feature detection, thereby avoiding a detection of the whole glass substrate and improving the sensitivity, rapidity and accuracy of the biological detection.

According to an aspect of the present disclosure, a target region analysis system for a biological detection is provided, the system includes:
a sample pushing mechanism used for pushing the liquid sample for a biological detection onto a detection glass substrate at a detection station, and sending out a detection execution request after the pushing is completed, and sending out a detection suspension request when the pushing is performed;
a macro capture mechanism arranged right above the detection station and connected with the sample pushing mechanism, and used for performing an image data capture operation on the environment where the detection station is located when the detection execution request is received to obtain a station environment image;
a filtering processing mechanism arranged near the detection station, and used for performing a Gaussian low-pass filtering action on the received station environment image to obtain a filtered image;
a directional elimination mechanism arranged on a left side of the filtering processing mechanism and connected with the filtering processing mechanism, and used for performing a directional elimination action on salt-and-pepper noises of the received filtered image to obtain a salt-pepper eliminated image;
a content processing mechanism arranged on a right side of the filtering processing mechanism and connected with the directional elimination mechanism, and used for performing a morphological processing on the received salt-pepper eliminated image to obtain an image to be processed;
a gradient analysis device arranged near the detection station and connected with the content processing mechanism, and used for performing a gradient analysis on each pixel point in the image to be processed to obtain each pixel point with the pixel value gradient exceeding a limit in the image to be processed as target pixel points;
a fitting operation device connected with the gradient analysis device and used for fitting each of the target pixel points in the image to be processed to obtain a plurality of image regions in the image to be processed;
and a region identification device connected with the fitting operation device and used for comparing a plurality of image areas respectively corresponding to a plurality of image regions in the image to be processed, and outputting the image region with the largest image area as a region to be detected for performing the biological detection;
where comparing a plurality of image areas respectively corresponding to a plurality of image regions in the image to be processed, and outputting the image region with the largest image area as the region to be detected for performing the biological detection includes: outputting the image region closest to a central pixel point of the image to be processed as the region to be detected for performing the biological detection when more than two image regions with a same and largest image area exist.

According to another aspect of the present disclosure, a target region analysis method for a biological detection is also provided, and the method includes following steps:
S1, using a sample pushing mechanism to push the liquid sample for a biological detection onto a detection glass substrate at a detection station, send out a detection execution request after the pushing is completed, and send out a detection suspension request when the pushing is performed;
S2, using a macro capture mechanism arranged right above the detection station and connected with the sample pushing mechanism to perform an image data capture operation on the environment where the detection station is located when the detection execution request is received to obtain a station environment image;
S3, using a filtering processing mechanism arranged near the detection station to perform a Gaussian low-pass filtering action on the received station environment image to obtain a filtered image;
S4, using a directional elimination mechanism arranged on a left side of the filtering processing mechanism and connected with the filtering processing mechanism to perform a directional elimination action on salt-pepper noises of the received filtered image to obtain a salt-pepper elimination image;
S5, using a content processing mechanism arranged on a right side of the filtering processing mechanism and connected with the directional elimination mechanism to perform a morphological processing on the received salt-pepper eliminated image to obtain an image to be processed;
S6, using a gradient analysis device arranged near the detection station and connected with the content processing mechanism to perform a gradient analysis on each pixel point in the image to be processed to obtain each pixel point with the pixel value gradient exceeding the limit as target pixel points;
S7, using a fitting operation device connected with the gradient analysis device to fit each of the target pixel points in the image to be processed to obtain a plurality of image regions in the image to be processed; and
S8, using a region identification device connected with the fitting operation device to compare a plurality of image areas respectively corresponding to a plurality of image regions in the image to be processed, and outputting the image region with the largest image area as a region to be detected for performing the biological detection;
where comparing a plurality of image areas respectively corresponding to a plurality of image regions in the image to be processed, and outputting the image region with the largest image area as the region to be detected for performing the biological detection includes: outputting the image region closest to a central pixel point of the image to be processed as the region to be detected for performing the biological detection when more than two image regions with a same and largest image area exist.

The target region analysis system and the target region analysis method for biological detection of the present disclosure are widely used in operation identification. The disclosure may introduce the targeted pixel value gradient analysis mechanism and the image region comparison mechanism to segment the image region of the biological detection liquid sample with uneven shape spreading on the glass substrate as a whole, so as to avoid detecting the whole glass substrate and reduce the calculation amount of biological detection.

### BRIEF DESCRIPTION OF THE DRAWINGS

Embodiments of the present disclosure are described below with reference to the accompanying drawings, where

FIG. 1 is a structural block diagram of a target region analysis system for biological detection according to an embodiment A of the present disclosure.

FIG. 2 is a flowchart of a target region analysis method for biological detection according to an embodiment B of the present disclosure.

### DETAILED DESCRIPTION OF THE EMBODIMENTS

Embodiments of the target region analysis system and the target region analysis method for biological detection of the present disclosure are described in detail with reference to the attached drawings.

### Embodiment A

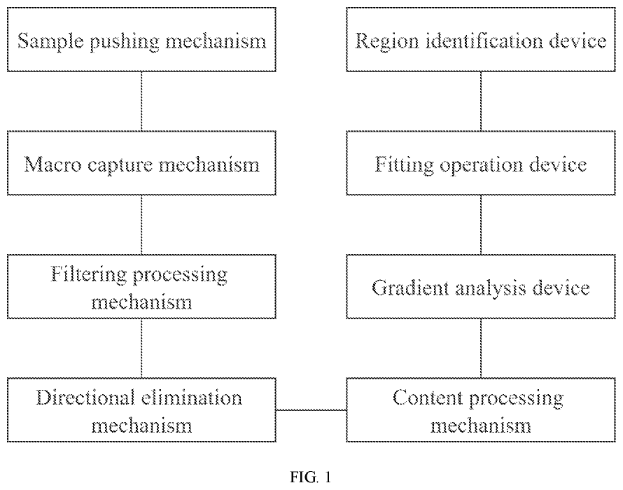

FIG. 1 is a structural block diagram of a target region analysis system for biological detection according to the embodiment A of the present disclosure, the system includes:
a sample pushing mechanism used for pushing the liquid sample for a biological detection onto a detection glass substrate at a detection station, and sending out a detection execution request after the pushing is completed, and sending out a detection suspension request when the pushing is performed;
a macro capture mechanism arranged right above the detection station and connected with the sample pushing mechanism, and used for performing an image data capture operation on the environment where the detection station is located when the detection execution request is received to obtain a station environment image;
a filtering processing mechanism arranged near the detection station, and used for performing a Gaussian low-pass filtering action on the received station environment image to obtain a filtered image;
a directional elimination mechanism arranged on a left side of the filtering processing mechanism and connected with the filtering processing mechanism, and used for performing a directional elimination action on salt-and-pepper noises of the received filtered image to obtain a salt-pepper eliminated image;
a content processing mechanism arranged on a right side of the filtering processing mechanism and connected with the directional elimination mechanism, and used for performing a morphological processing on the received salt-pepper eliminated image to obtain an image to be processed;
it may be seen that by introducing an image content enhancement mechanism including gradients of the filtering processing mechanism, the directional elimination mechanism and the content processing mechanism, the clarity of an imaging picture for identifying the biological detection region is ensured;
a gradient analysis device arranged near the detection station and connected with the content processing mechanism, and used for performing a gradient analysis on each pixel point in the image to be processed so as to obtain each pixel point with the pixel value gradient exceeding the limit in the image to be processed as target pixel points;
a fitting operation device connected with the gradient analysis device and used for fitting each of the target pixel points in the image to be processed to obtain a plurality of image regions in the image to be processed; and
a region identification device connected with the fitting operation device and used for comparing a plurality of image areas respectively corresponding to a plurality of image regions in the image to be processed, and outputting the image region with the largest image area as a region to be detected for performing the biological detection;
where comparing a plurality of image areas respectively corresponding to a plurality of image regions in the image to be processed, and outputting the image region with the largest image area as the region to be detected for performing the biological detection includes: outputting the image region closest to a central pixel point of the image to be processed as the region to be detected for performing the biological detection when more than two image regions with a same and largest image area exist;
for example, the area of each image region may be compared with the area of other image regions according to the area ratio of each image region occupying the image to be processed. For example, when the area ratio of the image region A occupying the image to be processed is greater than the area ratio of the image region of the image region B occupying the image to be processed, it may be determined that the area of the image region A is greater than the area of the image region B;
on the contrary, when the area ratio of the image region A occupying the image to be processed is smaller than the area ratio of the image region B, it may be determined that the area of the image region A is smaller than the area of the image region B.

It can be seen that by introducing a targeted pixel value gradient analysis mechanism, the biological detection region is identified for the imaging picture of the biological detection liquid sample located on the detection glass substrate, where the image region with the largest area and close to the center of the imaging field of view among a plurality of image regions fitted by each pixel point with the pixel value gradient exceeding the limit is taken as the biological detection region.

Next, the specific structure of the target region analysis system for the biological detection of the present disclosure is further described.

The target region analysis system for biological detection may further includes:
a data correction mechanism connected with the macro capture mechanism and used for correcting a capture frame rate and a capture resolution when the macro capture mechanism performs the image data capture operation on the environment where the detection station is located;
a serial port configuration mechanism respectively connected with the filtering processing mechanism, the directional elimination mechanism, the content processing mechanism and the gradient analysis device;
where the serial port configuration mechanism is used for performing time-sharing configuration of working parameters for the filtering processing mechanism, the directional elimination mechanism, the content processing mechanism and the gradient analysis device respectively;
where the serial port configuration mechanism is used for performing time-sharing configuration of working parameters for the filtering processing mechanism, the directional elimination mechanism, the content processing mechanism and the gradient analysis device respectively, including that the filtering processing mechanism, the directional elimination mechanism, the content processing mechanism and the gradient analysis device respectively have different serial port configuration addresses.

In the target region analysis system for the biological detection:
comparing a plurality of image areas respectively corresponding to a plurality of image regions in the image to be processed, and outputting the image region with the largest image area as the region to be detected for performing the biological detection further includes: taking a total number of pixel points respectively occupied by each image region in the image to be processed as the image area respectively corresponding to each image area in the image to be processed.

In the target region analysis system for the biological detection:
performing a gradient analysis on each pixel point in the image to be processed to obtain each pixel point with the pixel value gradient exceeding the limit and taking as the target pixel points includes: for each pixel point in the image to be processed, when the difference between the average value of each pixel value respectively corresponding to each pixel point around the each pixel point in the image to be processed and the pixel value of the each pixel point in the image to be processed is greater than or equal to the set difference threshold, taking the each pixel point in the image to be processed as the pixel point with the pixel value gradient exceeding the limit and taking the each pixel point in the image to be processed as the target pixel point.

And in the target region analysis system for the biological detection:
the gradient analysis device is also used for performing a pixel value gradient analysis on each pixel point in the image to be processed to obtain each pixel point in the image to be processed with the pixel value gradient not exceeding the limit as non-target pixel points;
where the macro capture mechanism is further used for suspending the image data capture operation for the environment where the detection station is located when a detection suspension request is received.

### Embodiment B

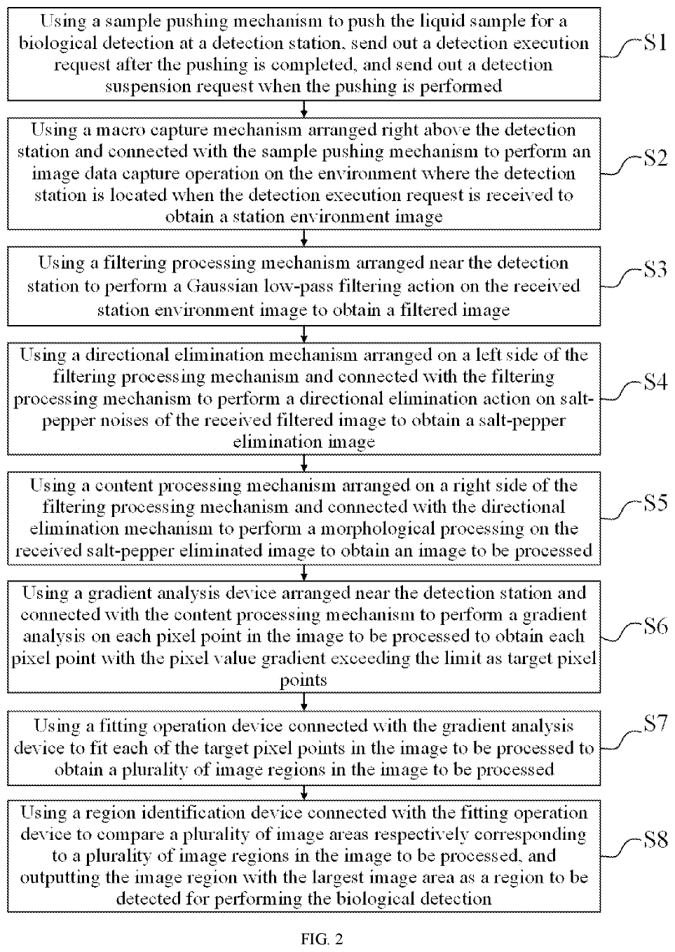

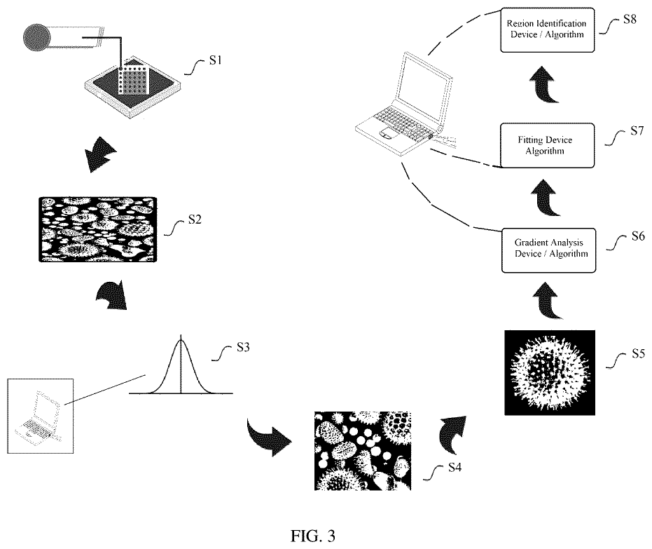

FIG. 2 is a flowchart of steps of a target region analysis method for a biological detection according to the embodiment B of the present disclosure, the method includes:
S1, using a sample pushing mechanism to push the liquid sample for a biological detection at a detection station, send out a detection execution request after the pushing is completed, and send out a detection suspension request when the pushing is performed;
S2, using a macro capture mechanism arranged right above the detection station and connected with the sample pushing mechanism to perform an image data capture operation on the environment where the detection station is located when the detection execution request is received to obtain a station environment image;
S3, using a filtering processing mechanism arranged near the detection station to perform a Gaussian low-pass filtering action on the received station environment image to obtain a filtered image;
S4, using a directional elimination mechanism arranged on a left side of the filtering processing mechanism and connected with the filtering processing mechanism to perform a directional elimination action on salt-pepper noises of the received filtered image to obtain a salt-pepper elimination image;
S5, using a content processing mechanism arranged on a right side of the filtering processing mechanism and connected with the directional elimination mechanism to perform a morphological processing on the received salt-pepper eliminated image to obtain an image to be processed;
S6, using a gradient analysis device arranged near the detection station and connected with the content processing mechanism to perform a gradient analysis on each pixel point in the image to be processed to obtain each pixel point with the pixel value gradient exceeding the limit as target pixel points;
S7, using a fitting operation device connected with the gradient analysis device to fit each of the target pixel points in the image to be processed to obtain a plurality of image regions in the image to be processed; and
S8, using a region identification device connected with the fitting operation device to compare a plurality of image areas respectively corresponding to a plurality of image regions in the image to be processed, and outputting the image region with the largest image area as a region to be detected for performing the biological detection;
where comparing a plurality of image areas respectively corresponding to a plurality of image regions in the image to be processed, and outputting the image region with the largest image area as the region to be detected for performing the biological detection includes: outputting the image region closest to a central pixel point of the image to be processed as the region to be detected for performing the biological detection when more than two image regions with a same and largest image area exist;
for example, the area of each image region may be compared with the area of other image regions according to the area ratio of each image region occupying the image to be processed. For example, when the area ratio of the image region A occupying the image to be processed is greater than the area ratio of the image region of the image region B occupying the image to be processed, it may be determined that the area of the image region A is greater than the area of the image region B;
on the contrary, when the area ratio of the image region A occupying the image to be processed is smaller than the area ratio of the image region B, it may be determined that the area of the image region A is smaller than the area of the image region B.

Next, the specific steps of the target region analysis method for the biological detection of the present disclosure is further described.

The target region analysis method for the biological detection may further includes:
using a data correction mechanism connected with the macro capture mechanism to correct a capture frame rate and a capture resolution when the macro capture mechanism performs the image data capture operation on the environment where the detection station is located;
using a serial port configuration mechanism to respectively connect with the filtering processing mechanism, the directional elimination mechanism, the content processing mechanism and the gradient analysis device;
where the serial port configuration mechanism is used for performing time-sharing configuration of working parameters for the filtering processing mechanism, the directional elimination mechanism, the content processing mechanism and the gradient analysis device respectively;
where the serial port configuration mechanism is used for performing time-sharing configuration of working parameters for the filtering processing mechanism, the directional elimination mechanism, the content processing mechanism and the gradient analysis device respectively, including that the filtering processing mechanism, the directional elimination mechanism, the content processing mechanism and the gradient analysis device respectively have different serial port configuration addresses.

In the target region analysis method for the biological detection:
comparing a plurality of image areas respectively corresponding to a plurality of image regions in the image to be processed, and outputting the image region with the largest image area as the region to be detected for performing the biological detection further includes: taking a total number of pixel points respectively occupied by each image region in the image to be processed as the image area respectively corresponding to each image area in the image to be processed.

In the target region analysis method for the biological detection:
performing a gradient analysis on each pixel point in the image to be processed to obtain each pixel point with the pixel value gradient exceeding the limit and taking as the target pixel points includes: for each pixel point in the image to be processed, when the difference between the average value of each pixel value respectively corresponding to each pixel point around the each pixel point in the image to be processed and the pixel value of the each pixel point in the image to be processed is greater than or equal to the set difference threshold, taking the each pixel point in the image to be processed as the pixel point with the pixel value gradient exceeding the limit and taking the each pixel point in the image to be processed as the target pixel point.

And in the target region analysis method for the biological detection:
the gradient analysis device is also used for performing a pixel value gradient analysis on each pixel point in the image to be processed to obtain each pixel point in the image to be processed with the pixel value gradient not exceeding the limit as non-target pixel points;
where the macro capture mechanism is further used for suspending the image data capture operation for the environment where the detection station is located when a detection suspension request is received.

In addition, in the target region analysis system and the target region analysis method for the biological detection, the gradient analysis device is also used for performing the pixel value gradient analysis on each pixel point in the image to be processed to obtain each pixel point in the image to be processed with the pixel value gradient not exceeding the limit as non-target pixel points includes: for each pixel point in the image to be processed, when the difference between the average value of pixel values corresponding to pixel points around the each pixel point and the pixel value of the each pixel point is less than the set difference threshold, taking the each pixel point as the non-target pixel point with the pixel value gradient not exceeding the limit and taking the each pixel point as the non-target pixel points.

Furthermore, the embodiments of the present disclosure are not limited to the above-mentioned embodiments, and various changes may be made within the scope without departing from the principal of the present disclosure.

1. A target region analysis method for a biological detection, comprising:
pushing a liquid sample for a biological detection onto a detection glass substrate at a detection station, and sending out a detection suspension request when the pushing is performed, and sending out a detection execution request after a pushing of the liquid sample is completed;
performing an image data capture operation on an environment where the detection station is located when the detection execution request is received to obtain a station environment image;
performing a Gaussian low-pass filtering action on the station environment image received to obtain a filtered image;
performing a directional elimination action on salt-and-pepper noises of the filtered image received to obtain a salt-pepper eliminated image;
performing a morphological processing on the salt-pepper eliminated image received to obtain an image to be processed;
performing a pixel value gradient analysis on each pixel point in the image to be processed to obtain each pixel point with a pixel value gradient exceeding a limit in the image to be processed as target pixel points; and
fitting each of the target pixel points in the image to be processed to obtain a plurality of image regions in the image to be processed followed by comparing a plurality of image areas respectively corresponding to the plurality of image regions in the image to be processed, and outputting an image region with a largest image area as a region to be detected for performing the biological detection;
wherein comparing the plurality of image areas respectively corresponding to the plurality of image regions in the image to be processed, and outputting the image region with the largest image area as the region to be detected for performing the biological detection comprises: outputting an image region closest to a central pixel point of the image to be processed as the region to be detected for performing the biological detection when more than two image regions with a same and largest image area exist.

2. The target region analysis method for the biological detection according to claim 1, wherein
comparing a plurality of image areas respectively corresponding to a plurality of image regions in the image to be processed, and outputting the image region with the largest image area as the region to be detected for performing the biological detection further comprises: taking a total number of pixel points respectively occupied by each image region in the image to be processed as the image area respectively corresponding to each image area in the image to be processed.

3. The target region analysis method for the biological detection according to claim 1, wherein
performing a gradient analysis on each pixel point in the image to be processed to obtain each pixel point with the pixel value gradient exceeding the limit and taking as the target pixel points comprises: for each pixel point in the image to be processed, when a difference between an average value of each pixel value respectively corresponding to each pixel point around it and its pixel value is greater than or equal to a set difference threshold, taking it as a pixel point with a pixel value gradient exceeding a limit and taking it as the target pixel point.

4.-8. (canceled)
